(19) United States
(12) Patent Application Publication
(10) Pub. No.: US 2015/0211350 A1
(43) Pub. Date: Jul. 30, 2015

(54) Method for Monitoring and Controlling Drilling Fluids Process

(71) Applicants: Jason Brian Norman, Houston, TX (US); William Gerald Lott, Houston, TX (US)

(72) Inventors: Jason Brian Norman, Houston, TX (US); William Gerald Lott, Houston, TX (US)

(73) Assignee: ONSITE INTEGRATED SERVICES LLC, Houston, TX (US)

(21) Appl. No.: 14/604,958

(22) Filed: Jan. 26, 2015

Related U.S. Application Data
(60) Provisional application No. 61/965,260, filed on Jan. 27, 2014.

(51) Int. Cl. E21B 44/00; E21B 49/00; G05B 15/02; E21B 49/08

(52) U.S. Cl. CPC E21B 44/00; E21B 49/08; E21B 49/003; G05B 15/02

(57) ABSTRACT

A method for continuously determining characteristics of a process fluid includes inline real-time analysis. In one embodiment, inline analysis of water, oil, and salt anions provides continuously obtained measurements for determination of various drilling fluid properties and assessment of drilling operation parameters and wellbore conditions. In one embodiment, the continuously provided measurements and/or data calculated therefrom allow for monitoring and controlling of a downhole drilling operation. In embodiments of the method, automated control of drilling operations using the continuously generated information can be accomplished. In one embodiment, a material balance of drilling fluid components using the continuously generated information is provided.

### CROSS-REFERENCE TO RELATED APPLICATIONS

This application claims the benefit of U.S. Provisional Application No. 61/965,260, entitled “Utilize flow rate, density, salinity and water cut inline instrumentation to optimize the drilling fluids process,” filed on Jan. 27, 2014, which application is incorporated herein by reference as if reproduced in full below.

### STATEMENT REGARDING FEDERALLY SPONSORED RESEARCH OR DEVELOPMENT

Not Applicable.

### BACKGROUND OF THE INVENTION

1. Field of the Invention

Oil and gas well drilling operations typically involve the use of a drilling fluid slurry, also sometimes referred to as “mud.” Mud may contain aqueous and non-aqueous components and form emulsions thereof. Typically present in the mud during drilling operations are (water and/or oil) insoluble materials (“solids”), such as salts (e.g., calcium chloride), minerals (e.g., barite), additives, and drill cuttings. Determination of the amounts and/or relative concentrations of the various components of the mud is useful in more effectively and safely performing the drilling operations.

2. Related Art

Analyses of mud characteristics have been previously been accomplished; however, such measurements normally require the collection of process samples and subsequent laboratory testing. A typical “retort” analysis allows for the determination of the relative amounts of water, oil, and solids by simple laboratory distillation. Information regarding the composition of the solids may obtained by further analysis thereof. For example, U.S. Pat. No. 5,519,214 to Houwen et al. describes a laboratory process of solids analysis employing X-ray fluorescence (XRF) to characterize various chemical components of the solids. Conventionally, process mud samples are collected every 6-24 hours. Even if samples are collected and analyzed more frequently, there is still a substantial gap in time between the when the mud characteristics are present in the drilling operation, (i.e., when the sample is obtained), and when the laboratory testing results are available.

Inline process parameter measurement is also known in the art. U.S. Pat. No. 8,561,720 to Edbury et al. discloses a method of assessing hole cleaning effectiveness based on inline drilling fluid measurements of density, mass flow, temperature, and viscosity. PCT Patent Application Publication No. WO 2012/016045 similarly discloses measuring various in-process mud characteristics. These methodologies are, however, limited by mud characteristic information obtainable thereby.

### BRIEF SUMMARY OF THE INVENTION

The present invention relates generally to methods for characterizing a process fluid by in-process measurements that allow for continuously obtaining information regarding relative and actual amounts of various components thereof. Various embodiments comprise continuously quantifying the amounts of water and non-aqueous liquids (e.g., oil) in a mud, as well as the salt anion content of a mud. Various embodiments comprise determining and/or calculating the amount of various mud characteristics, such as solids, salinity, and oil/water ratio, in substantially real time. The present invention also relates generally to methods for utilizing continuously obtained downhole information to identify and monitor then present, undesired downhole drilling phenomena and control drilling operations based on such identification, and methods for utilizing continuously obtained downhole information to identify and monitor potential, undesired downhole drilling phenomena and control drilling operations based on such identification.

Other features and advantages of embodiments of the invention will be apparent from the following description, the accompanying drawing, and the appended claims.

### BRIEF DESCRIPTION OF THE DRAWINGS

FIG. 1 depicts an embodiment of a method of the present invention.

### DETAILED DESCRIPTION OF EMBODIMENTS OF THE INVENTION

During a drilling operation, the drilling mud may comprise water, one or more oil-based drilling fluids and/or one or more synthetic drilling fluids, salts (e.g., calcium chloride (CaCl₂)), minerals (e.g., barite), viscosifiers, emulsifiers, wetting agents, additional chemical or biological additives, and drill cuttings. Thus, a mud may therefore comprise a slurry of fluid and insoluble materials suspended or otherwise entrained therein. While embodiments of the method described herein are generally applicable to fluids, certain embodiments may refer specifically to mud. Such reference is merely exemplary and not limiting in terms of the applicability of embodiments of the present invention to other fluids or fluid/solid mixtures. Fluids to which embodiments of the present invention may be employed may comprise an oil/water emulsion or a water/oil emulsion. In addition, fluids employable in embodiments of the present invention may comprise various salts or mixture of salts. Typically in drilling operations, the salt employed, such as for shale stability, is calcium chloride, and certain embodiments herein may refer specifically to calcium chloride as the salt and/or chloride as the anion thereof. Such reference is merely exemplary and not limiting in terms of the applicability of embodiments of the present invention to fluids comprising other salts or mixtures of salts.

Fluids to which methods of the present invention may be employed include drilling mud being used in a drilling operation. In various embodiments of the present invention, the methods, measurements, and/or calculations described herein are performed on both the drilling mud contained within a wellbore suction line and the drilling mud contained within a wellbore return line, so that results are obtained for the fluid entering and exiting the wellbore, respectively.

In one aspect of the present invention, certain characteristics of a fluid, such as a drilling mud, are obtained. Characteristics of the “base mud” (mud material as originally introduced to the wellbore) and/or characteristics of the “active mud” (mud as is currently contained within the wellbore) are estimated, provided, obtained, and/or calculated. In certain embodiments, various characteristics of the active mud are measured via inline (on-line) instruments wherein the measurement information is obtained as real-time data or near real-time data. In certain embodiments, the on-line measurement information, as well as other information and data, are communicated to and/or stored within a processing device, including but not limited to, a computerized instrument, such as a programmable logic controller (PLC), which is adapted to communicate information and data, directly or indirectly, to a drill crew, and/or utilize the information and data, directly or indirectly, to control one or more devices during a drilling operation.

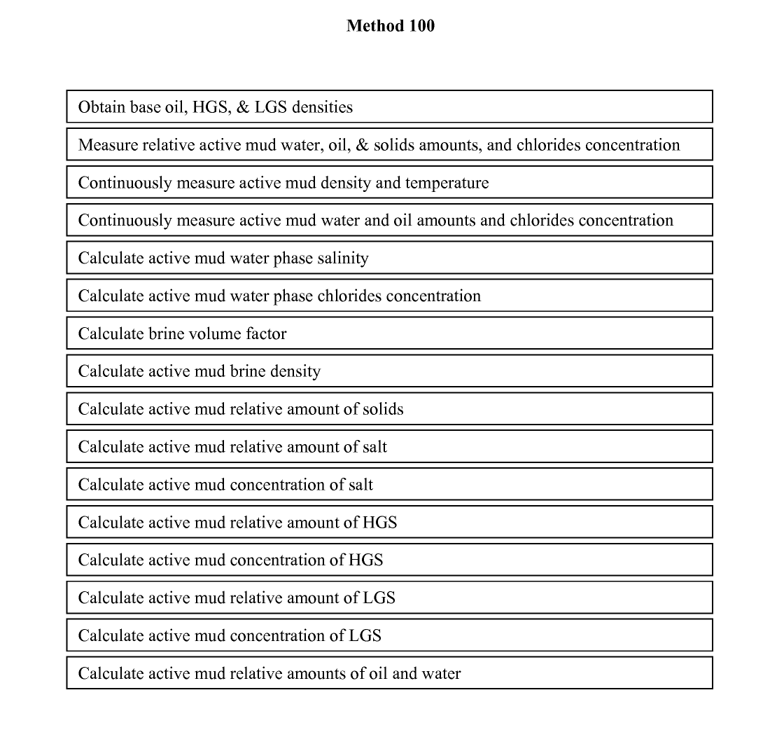

Referring now to the drawings, FIG. 1 depicts an embodiment of a method 100 of the present invention whereby various fluid characteristics and/or properties may be ascertained. The number and order of steps shown in FIG. 1 is only exemplary of an embodiment of the present invention; additional embodiments may duplicate certain steps, delete certain steps, and/or comprise additional steps, comprise fewer or more steps, and/or comprise steps in a differing order. Moreover, in the embodiment depicted in FIG. 1, the order of the steps may be altered, as would be understood by one skilled in the art. In the determination steps, calculation steps, and Exemplary Calculation below, one or more components of a determination and/or calculation may comprise at least one estimation, approximation, and/or assumption relating to the qualities and/or quantification thereof.

The embodiment of the present method depicted by FIG. 1 comprises a plurality of determination steps. As shown in FIG. 1, the first determination step comprises obtaining the densities of the base oil (oil used to produce the base mud), low gravity solids (“LGS”), such as drill cuttings, and high gravity solids (“HGS”), such as barite, by known properties, measurement, and/or estimation.

The second determination step comprises measuring various characteristics of the active mud by standard methods as would be known to one skilled in the art. Such additional characteristics comprise the relative amount of water by volume percent, the relative amount of oil by volume percent, the relative amount of solids (soluble and insoluble) by volume percent, and the weight concentration of chlorides per unit volume. In one embodiment, such characteristics are measured by laboratory analyses. In operation, such laboratory measured characteristics may be used to calibrate various inline instruments which may be utilized in various embodiments of the present invention and/or corroborate measurements obtained therefrom.

The third determination step comprises continuously measuring the density and temperature of the active mud. Real-time density measurements can be collected via inline/on-line instruments utilizing Coriolis, Ultrasonic, Microwave, Magnetic Resonance Imaging, Pressure Differential, Nuclear, or Electromagnetic principles, or any other suitable inline on-line device, as is generally known in the art. In mud operations the typical density units used are kilograms per cubic meter (kg./m³) and/or pounds per gallon (lbs./gal.). Temperature may be measured in real time, such as by utilizing a thermocouple, resistance temperature detector (RTD), or other temperature measurement device as is known in the art, which may be provided as part of the density measurement device or as a stand-alone instrument.

The fourth determination step comprises continuously measuring the concentration of chlorides, the relative amount of water, and the relative amount of oil in the active mud. In one embodiment, the concentration of chlorides (“chlorides concentration”) is measured using an inline process analyzer utilizing Resonance-Enhanced Multivariate Impedance Spectroscopy (REMIS) technology. In one embodiment, the REMIS inline analytical instrument utilizes a resonant transducer, such as a type disclosed in U.S. Pat. No. 8,542,024 to Potyrailo et al., as well as United States Patent Applications Nos. 2013/0154847 (Potyrailo et al.), 2014/0090451 (Surman et al.), 2014/0090454 (Surman et al.), and 2014/0305194 (Surman et al.), each of which is incorporated herein by reference in its entirety. Generally, the inline analyzer quantifies the anion(s) (e.g., chloride) concentration in the active mud. In one aspect, the measured chlorides concentration in the active mud is expressed in weight of Calcium Chloride per unit volume of the active mud, such as in milligrams of chloride per liter of active mud.

Also in the fourth determination step, the relative amount of water present in the active mud (“water cut”) is measured. The water cut is defined as the volume of water present in a given volume of mud. A water cut measurement can be obtained via an inline instrument utilizing Ultrasonic, Magnetic Resonance Imaging (MRI), Dielectric Constant, Capacitance, Conductivity, Resistivity, Microwave, Resonance-Enhanced Multivariate Impedance Spectroscopy (REMIS) technology, or any other suitable on-line real time method. In one embodiment, the water cut measurement is accomplished by use of an inline REMIS analytical instrument that utilizes a resonant transducer, such as is disclosed above. Typically, the water cut is reported as a volume percentage of the total active mud.

Further in the fourth determination step, the relative amount of oil (“percentage oil”) in the active mud, as a volume percentage of the active mud, is measured. In one embodiment, the percentage oil measurement is accomplished by use of an inline REMIS analytical instrument that utilizes a resonant transducer, such as is disclosed above.

The embodiment of the present method depicted by FIG. 1 further comprises a plurality of calculation steps. These calculation steps are described in this section in general terms and will be described in more detail in the Exemplary Calculation disclosed below.

In the first calculation step, a “water phase salinity” of the active mud is calculated. As one skilled in the art would understand, it is assumed that all or substantially all of the salt is dissolved in the water portion (i.e., “brine” phase) of the active mud, and this result is referred to as water phase salinity. The salinity is calculated using the chlorides concentration, obtained in the fourth determination step, and the water cut, obtained in the fourth determination step. Water phase salinity is reported as a percentage.

In the related, second calculation step, a “water phase chlorides concentration” in the water phase (brine) of the active mud is calculated. This result, although also calculated using the chlorides concentration, obtained in the fourth determination step, and the water cut, obtained in the fourth determination step, differs from the water phase salinity. Specifically, water phase salinity is a measurement of weight percentage of a CaCl₂ solution, whereas water phase chlorides concentration is a measurement of concentration and is reported in weight per unit volumes, such as milligrams per liter.

In the third calculation step, a “brine volume factor” is calculated. The brine volume factor is calculated using the water phase chlorides concentration, obtained in the second calculation step, and is reported as a numerical value. The brine volume factor is used to determine the volumetric displacement effect of dissolved salt.

In the fourth calculation step, the density of the brine phase of the active mud (“brine density”) is calculated. This result is calculated using the water phase chlorides concentration, obtained the second calculation step. This brine density is reported as mass per unit volume, typically in kilograms per cubic meter (kg/m³).

In the fifth calculation step, the relative amount of solids “percentage solids” in the active mud is calculated. The percentage solids is calculated using the percentage oil, obtained in the fourth determination step, and the water cut, obtained in the fourth determination step. The percentage solids is reported as volume %.

In the sixth calculation step, the relative amount of salt “percentage salt” in the active mud is calculated. The percentage salt is calculated using the water cut, obtained in the fourth determination step; the brine density, obtained in the fourth calculation step; and the water phase salinity, obtained in the first calculation step. The percentage salt is reported as volume %.

In the seventh calculation step, the concentration of salt “salt concentration” in the active mud is calculated. The salt concentration is calculated using the chlorides concentration, obtained in the fourth determination step. The salt concentration is reported as weight per unit volume, typically in kilograms per cubic meter (kg/m³).

In the eighth calculation step, the relative amount of high gravity solids (HGS) (“percentage HGS”) in the active mud is calculated. The percentage HGS is calculated using the percentage oil, obtained in the fourth determination step; the density of the low gravity solids (LGS), obtained in the first determination step; the density of the base oil, obtained in the first determination step; the water cut, obtained in the fourth determination step; the brine volume factor, obtained in the third calculation step; the brine phase density, obtained in the fourth calculation step; the active mud density, obtained in the third determination step; and the density of the high gravity solids (HGS), obtained in the first determination step. The percentage HGS is reported as volume %.

In the ninth calculation step, the concentration of high gravity solids (HGS) (“HGS concentration”) in the active mud is calculated. The HGS concentration is calculated using the percentage HGS in the active mud, obtained in the eighth calculation step, and the density of the HGS, obtained in the first determination step. The HGS concentration is reported as weight per unit volume, typically in kilograms per cubic meter (kg/m³)

In the tenth calculation step, the relative amount of low gravity solids (LGS) (“percentage LGS”) in the active mud is calculated. The percentage LGS is calculated using the percentage oil, obtained from the fourth determination step; the water cut, obtained in the fourth determination step; the brine volume factor, obtained in the third calculation step; and the percentage HGS, obtained in the eighth calculation step. The percentage LGS is reported as volume %.

In the eleventh calculation step, the concentration of low gravity solids (LGS) (“LGS concentration”) in the active mud is calculated. The LGS concentration is calculated using the percentage LGS in the active mud, obtained in the ninth calculation step, and the density of the LGS, obtained in the first determination step. The LGS concentration is reported as weight per unit volume, typically in kilograms per cubic meter (kg/m³).

In the twelfth calculation step, the relative amounts of oil and water (“oil/water ratio”) of the active mud is calculated. The oil/water ratio is calculated by calculating the amount of oil in the liquid phase of the mud and the amount of water in the liquid phase of the mud. The amount of oil in the active mud is calculated using the percentage oil, obtained in the fourth determination step; the water cut, obtained in the fourth determination step; and the brine volume factor, obtained in the third calculation step. The amount of water in the active mud is calculated using the water cut, obtained in the fourth determination step; the brine volume factor, obtained in the third calculation step; and the percentage oil, obtained in the fourth determination step. The oil/water ratio is calculated by dividing the amount of oil in the active mud by the amount of water in the active mud corrected for salt.

In one embodiment, a continuous material balance of an active drilling mud can be estimated using method 100. An active drilling mud consists essentially of oil, water, one or more salts, high gravity solids, and low gravity solids. As shown in the Exemplary Calculation below, these components of an active drilling fluid can be determined or calculated.

### Exemplary Calculation

The calculation provided below describes how one embodiment of a method of the present invention would be utilized to characterize a drilling mud. Where indicated, equations and/or numerical factors have been taken from the American Petroleum Institute resource, Recommended Practice for Field Testing Oil-Based Drilling Fluids, API Recommended Practice 13B-2, Fifth Edition, (“API Standard RP”), which is incorporated herein by reference in its entirety, to the extent not inconsistent herewith.

In a determination step 1:

A. the density of a base oil is measured by known means or obtained from the manufacturer thereof and determined to be about 840 kg/m³.

B. the density of LDS (e.g., drill cuttings) (“LGS constant”) is measured by known means or estimated as is known in the art and determined to be about 2,650 kg/m³.

C. the density of HDS (e.g., barite) (“HGS constant”) is measured by known means or obtained from the manufacturer thereof and determined to be about 4,200 kg/m³.

In a determination step 2:

A. the relative volume amount of water in a volume of active mud is measured by known means, such as laboratory retort analysis, and determined to be about 25%.

B. the relative volume amount of oil in a volume of active mud is measured by known means, such as laboratory retort analysis, and determined to be about 59.5%.

C. the relative volume amount of solids (soluble and insoluble) in a volume of active mud is measured by known means, such as laboratory retort analysis, and determined to be about 15.5%.

D. the concentration of anions (e.g., chlorides) in a volume of active mud is measured by known means, such as laboratory titration, and determined to be about 58,000 mg/L.

In a determination step 3:

A. the density of the active mud (“mud density”) is measured by inline analysis, such as by a Coriolis type meter, and determined to be about 1,320 kg/m³.

B. the temperature of the active mud is measured by inline analysis, such as by an RTD device, and determined to be about 70° F. (21.1° C.).

In a determination step 4:

A. the concentration of anions (e.g., chlorides) in the active mud is measured by inline analysis, such as by a REMIS analytical instrument utilizing a resonant transducer, as is disclosed above, and determined to be about 58,000 mg/L.

B. the relative volume amount of water (water cut) in the active mud is measured by inline analysis, such as by a REMIS analytical instrument utilizing a resonant transducer, as is disclosed above, and determined to be about 25%.

C. the relative volume amount of oil in the active mud (“% oil”) is measured by inline analysis, such as by a REMIS analytical instrument utilizing a resonant transducer, as is disclosed above, and determined to be about 59.5%.

In a calculation step 1:

the water phase salinity (“WPS”) of the active mud is calculated using the API Standard RP, Annex E, as:

$$\begin{matrix}WPS = ( \frac{\frac{Chlorides Active Mud}{10 \text{,} 000} * 1.5652}{( \frac{Chlorides Active Mud}{10 \text{,} 000} * 1.5652 ) Water Cut} ) * 100 & \\ WPS = ( \frac{\frac{58 \text{,} 000}{10 \text{,} 000} * 1.5652}{( \frac{58 \text{,} 000}{10 \text{,} 000} * 1.5652 ) + 25} ) * 100 \\ Water Phase Salinity = 26.6 \% & \end{matrix}$$

In a calculation step 2:

the concentration of salt anions (e.g., chlorides) in the water phase of the active mud (water phase chlorides concentration) (“WPCC”) is calculated using the API Standard RP, Annex E, as:

$$WPCC = ( \frac{Chlorides Active Mud}{( \frac{Water Cut}{100} )} )$$

$$WPCC = ( \frac{58 \text{,} 000}{( \frac{25}{100} )} )$$

$$Water Phase Chlorides Concentration = 232 \text{,} 000 mg \text{/} L$$

In a calculation step 3:

the brine volume factor (“BVF”) is calculated by a basic physics calculation, as is known in the art, as:

BVF=1+(3*10⁻⁷*WPCC)+(5*10⁻¹³*WPCC²)+(4*10⁻¹⁹*WPCC³)

BVF=1+(3*10⁻⁷*232,000)+(5*10⁻¹³*232,000²)+(4*10⁻¹⁹*232,000³)

Brine Volume Factor=1.10

In a calculation step 4:
the density of the brine in the active mud (brine density) (“BD”) is calculated using the API Standard RP, Annex E, as:

BD=1000+(12*10⁻⁴*WPCC)−(4*10⁻¹⁰*WPCC²)+(9*10⁻¹⁷*WPCC³)

BD=1000+(12*10⁻⁴*232,000)−(4*10⁻¹⁰*232,000²)+(9*10⁻¹⁷*232,000³)

Brine Density=1,258 kg/m³

In a calculation step 5:

the relative amount of solids in the active mud (percentage solids) (“% solids”) is calculated using the API Standard RP, Annex E, as:

% Solids=100−% Oil−Water Cut

% Solids=100−59.5−25

% Solids=15.5%

In a calculation step 6:

the relative amount of salt (e.g., calcium chloride) in the active mud (percentage salt) (“% CaCl₂”) is calculated using the API Standard RP, Annex E, as:

$$\% {CaCl}_{2} = ( Water Cut * ( ( \frac{100}{( ( \frac{BD}{1 \text{,} 000} ) * ( 100 - WPS ) )} - 1 ) ) )$$

$$\% {CaCl}_{2} = ( 25 * ( ( \frac{100}{( ( \frac{1 \text{,} 258}{1 \text{,} 000} ) * ( 100 - 26.6 ) )} - 1 ) ) )$$

$$\% {CaCl}_{2} = 2.1 \%$$

In a calculation step 7:

the concentration of salt (e.g., calcium chloride) in the active mud (salt concentration) (“CaCl₂ Concentration”) is calculated using the API Standard RP, Annex E, as:

$${CaCl}_{2} Concentration = ( \frac{1 \text{,} 655 * Chlorides Active Mud}{1 \text{,} 000 \text{,} 000} )$$

$${CaCl}_{2} Concentration = ( \frac{1 \text{,} 655 * 58 \text{,} 000}{1 \text{,} 000 \text{,} 000} )$$

$${CaCl}_{2} Concentration = 96 kg \text{/} {m}^{3}$$

In a calculation step 8:

the relative amount of HGS (e.g., barite) in the active mud (“% HGS”) is calculated using the API Standard RP, Annex E, as:

$$\% HGS = \frac{\begin{matrix}\begin{matrix}\% Oil * ( \text{2,650} - 840 ) + \\ Water Cut * BVF *\end{matrix} \\ ( 2 \text{,} 650 - BD ) - 100 * ( 2 \text{,} 650 - Mud Density )\end{matrix}}{4 \text{,} 200 - 2 \text{,} 650}$$

$$\% HGS = ( \frac{\begin{matrix}\begin{matrix}( 59.5 * ( 2 \text{,} 650 - 840 ) ) + \\ ( 25 * 1.10 * ( 2 \text{,} 650 - 1 \text{,} 258 ) ) -\end{matrix} \\ ( 100 * ( 2 \text{,} 650 - 1 \text{,} 320 ) )\end{matrix}}{( 4 \text{,} 200 - 2 \text{,} 650 )} )$$

$$\% HGS = 8.4 \%$$

In a calculation step 9:

the concentration of HGS in the active mud (“HGS concentration) is calculated using the API Standard RP, Annex E, as:

$$HGS Concentration = \frac{\% HGS * HGS Constant}{100}$$

$$HGS Concentration = \frac{8.4 * 4 \text{,} 200}{100}$$

$$HGS Concentration = 353 kg \text{/} {m}^{3}$$

In a calculation step 10:

the relative amount of LGS (e.g., drill cuttings) in the active mud (“% LGS”) is calculated using the API Standard RP, Annex E, as:

% LGS=100−% Oil−Water Cut*BVF−% HGS

% LGS=100−59.5−25*1.10−8.4%

LGS=4.6%

In a calculation step 11:

the concentration of LGS in the active mud (“LGS concentration) is calculated using the API Standard RP, Annex E, as:

$$LGS Concentration = \frac{\% LGS * LGS Constant}{100}$$

$$LGS Concentration = \frac{4.6 * 2 \text{,} 650}{100}$$

$$LGS Concentration = 121 kg \text{/} {m}^{3}$$

In a calculation step 12:

the oil/water ratio in the active mud is calculated, by calculating the relative amounts of oil (“ratio oil”) and water (“ratio oil”) in the active mud, using the API Standard RP, Annex E, as:

$$Ratio Oil = ( \frac{100 * \% Oil}{\% Oil + Water Cut * BVF} )$$

$$Ratio Oil = ( \frac{100 * 59.5}{59.5 + 25 * 1.10} )$$

$$Ratio Oil = 68$$

$$Ratio Water = ( \frac{100 * Water Cut * BVF}{\% Oil + Water Cut * BVF} )$$

$$Ratio Water = ( \frac{100 * 25 * 1.10}{59.5 + 25 * 1.10} )$$

$$Ratio Water = 32$$

$$Ratio Oil / Water = ( \frac{Ratio Oil}{Ratio Water} )$$

$$Ratio Oil / Water = ( \frac{68}{32} )$$

### Methods for Monitoring and Controlling

In various embodiments of the present invention, a well drilling process may be monitored and/or controlled utilizing continuously obtained drilling fluid characteristic information. As used herein to describe the inline analyses performed by on-line instruments, and/or the information/data obtained or derived therefrom, the terms “continuous” and “continuously” include sensing, measuring, calculating and/or performing other functions on a constant basis, a substantially constant basis (e.g., at the maximum repetitive capabilities of the instrument), or a repetitive intermittent basis. In various embodiments, determinations made using the obtained drilling fluid characteristic information, and/or calculations described herein or otherwise known, allow for estimation regarding drilling fluid properties or qualities, and/or drilling operation performance, conditions, situations, or events. In various embodiments, continuously obtained data is communicated to a drill crew. This communication may be in the form of electronic notification, alert, or alarm (e.g., via computer), and/or non-computerized notification, alert, or alarm, including but not limited to, visual, audial, and mechanical events.

In one aspect, by continuously obtaining the water cut, percentage oil, and chlorides concentration, a complete solids determination, and therefore a quantification of drill cuttings removal from the well, can be determined on a continuous basis. By calculating the relative amounts of HGS & LGS going into the well and exiting the well, the concentration of drilled solids in the drilling fluid can be calculated, and near real-time data quantifying the amount of drilled solids being removed from the well can be continuously obtained. The mass of rock excavated during a drilling interval can be estimated, based on drilling parameters, information about the formation, and drilling history. Thus, from the continuously obtained solids data, wellbore cleaning efficiency can be estimably determined. If the wellbore cleaning efficiency significantly deteriorates, a decrease in the concentration of low gravity solids removed from the well occurs. Traditionally, this decrease in wellbore cleaning efficiency is only observed over time, the length of such time being dependent on the frequency of the off-line (i.e., laboratory) analyses performed. Once such a determination of wellbore cleaning efficiency decrease is finally made, the drill crew performs some form of remedial hole cleaning technique, such as pumping a sweep or circulating a bottoms-up clean up cycle, is initiated. A sweep typically entails a small amount (30-50 barrels) of either a high viscosity or high density fluid being introduced to the wellbore to remove excess drilled cuttings therefrom. Circulating bottoms-up involves circulating an entire annular volume of fluid without drilling any additional new hole. Both of these remedial measures result in lost rig time and are therefore undesirable. In an embodiment of a method of the present invention, continuously obtained solids concentration information is utilized to monitor and control the process in a manner that avoids having to resort to such costly remedial measures. In one embodiment, if the continuously obtained solids data is indicative of a decrease in wellbore cleaning efficiency, this can be communicated, either directly or indirectly, to the drill crew so that drilling parameters can be modified to attempt to prevent a cleaning event necessitating such a remedial measure. In one embodiment, a computerized instrument, such as a programmable logic controller (PLC), can be utilized to automatically modify drilling parameters based on the continuously obtained solids data being communicated, either directly or indirectly, thereto.

In another aspect, by continuously obtaining the complete solids characterization going into and out of a particular solids control device, a system performance (SP) calculation can be determined in near real time. In drilling operations, it is known in the art that there exists a direct relationship between an increase in solids concentration in the active mud and changes in equivalent circulating density (ECD). In fact, even a relatively small increase in solids concentration can potentially lead to a serious well control event. Continuous monitoring of solids concentration provides near real-time data that allows for prevention or mitigation of well control events. A small hole in a shaker screen can lead to an increase in drilled solids in the circulatory system that compounds over time if repairs are not timely made. This increase in drilled solids can lead to an increase in plastic viscosity which will increase the ECD of the active mud system. This increase in ECD can provide the basis for a loss circulation event. A loss circulation event can lead to an uncontrolled well incident or blow out. Moreover, a small hole in a shaker screen can quickly become a much larger hole, which can produce a rapid increase of drilled solids in the circulatory system, and has even more potential to result in an uncontrolled well incident or blow out. By calculating the relative concentrations of high gravity solids (HGS) and low gravity solids (LGS) entering and exiting solids control devices including, but not limited to, a shale shaker, a centrifuge, a de-sander, and/or de-silter, real-time data quantifying of the amount of drilling fluids waste being removed from the circulatory system can be continuously evaluated. Quantifying this waste is valuable when determining the current efficiency of each piece of equipment. In one embodiment, if the solids data continuously obtained by the on-line analytical instruments is indicative of a significant decline in the systems performance of a specific solids control device, this can be communicated, either directly or indirectly, to the drill crew so that device operating parameters can be modified to attempt to improve device performance. In one embodiment, a computerized instrument, such as a programmable logic controller (PLC), can be utilized to automatically modify a specific solids control device operating parameters based on the continuously obtained solids data being communicated, either directly or indirectly, thereto.

In another aspect, a rapid wellbore influx (undesirable flow of liquid into the wellbore) can be caused by formation fluid rapidly entering into the wellbore and/or a drill crew operations error. This rapid influx, also known as “kick,” is indicated by the rapid increase in drilling fluid volume while circulating, and can be quantified on a continuous basis. An influx of water, without therein being an adequate concentration of emulsifier, wetting agent, and lime added to accommodate the water influx, can lead to a phenomenon known in the art as “clobbered up” or “gelled up” mud, whereby the active mud system can become undesirably highly viscous. Water influx issues can also result in fluctuations in equivalent circulating density (ECD)/equivalent static density (ESD), and circulating pressure, as well as reduced pump rate, and can induce formation losses, which result in surge/swab issues, and significantly, the cost/time of treatment. Continuous inline water cut and chlorides concentration measurements at the flow line exiting the wellbore can indicate a water influx and whether the influx was due to fresh water or saltwater, and action can be taken to immediately to, for example, treat the contaminated mud using an adequate amount of specific product(s) (e.g., emulsifier, wetting agent, and/or lime) to quickly adjust the mud properties, thereby preventing re-circulating the “clobbered up” mud back down the wellbore where it can potentially result in NPT (non-productive time) and/or a shutdown Changes in chlorides concentration and/or water cut can be directly correlated to the type and cause of a wellbore influx. In one aspect, a wellbore influx can be identified in near real time, and it can be determined if the influx was caused by a freshwater flow, saltwater flow, and/or an influx of liquid hydrocarbons (e.g., oil). Any rapid increase in the water cut will indicate that the influx is water and not hydrocarbon, while any increase in chlorides concentration will indicate that the water flow is salt water and not fresh water. Any rapid increase in the percentage oil in the mud will indicate that the influx is hydrocarbon and not water. In addition, by utilizing the real-time density measurement it can be determined if the kick involves an influx of gas. Any “sharp” decrease in density, accompanied by a “sharp” drop in water cut as well as a “sharp” drop in the percentage oil (as the term “sharp” would be used by one skilled in the art to describe these phenomena), will correlate to a common gas kick. A particular kick event may comprise an influx of (fresh or salt) water and/or liquid hydrocarbons and/or gas. In one embodiment, if the continuously obtained water cut, chlorides concentration, percentage oil, and density data indicate conditions consistent with a wellbore influx (kick), this information can be communicated, either directly or indirectly, to the drill crew so that appropriate drilling operation and/or mud parameters can be adjusted. In one embodiment, a computerized instrument, such as a programmable logic controller (PLC), can be utilized to automatically adjust the drilling operation and/or mud parameters as would be desired in a particular wellbore influx (kick) situation, based on the continuously obtained water cut, chlorides concentration, percentage oil, and density data being communicated, either directly or indirectly, thereto.

Another normal occurrence drilling operations is loss of water into the formation. Such migration of water into the formation occurs when drilling mud penetrates the formation and properties of the formation result in retention of water therein. In typical drilling operations, a filter cake, (composite of various solids suspended in the active mud), is deposited within the porous media of the formation when mud enters the formation. This deposition of filter cake is used to control the amount of filtrate being lost to the formation at all times, and thus excess water retention in the formation can be due to inadequate filter cake quality. This formation fluid loss can be controlled using specific drilling fluid products that form the filter cake. One detrimental effect of excessive amounts of water lost to the formation is the potential for an inadequate bond between the casing and the wellbore wall during cementing operations. Continuous monitoring of water losses from the active mud into the formation, using the continuously obtained water cut data, provides information that can be used to make determinations regarding the viability and/or requisite methodology of future cementing operations. In one embodiment, if the continuously obtained water cut data is indicative of unacceptable water loss into the formation, (e.g., exceeds a specified amount), this information can be communicated, either directly or indirectly, to the drill crew so that fluid treatment options can be timely initiated to avoid the possibility of having to perform costly cement job remediation procedures. In one embodiment, a computerized instrument, such as a programmable logic controller (PLC), can be utilized to automatically adjust the drilling operations as would be desired in such a water loss situation based on the continuously obtained water cut data being communicated, either directly or indirectly, thereto.

Water and salt content in the active mud affect drilling operations in additional ways. For instance, the combination of a high salinity formation and low salinity drilling fluid can result in an osmotic flow of water from drilling fluid into the formation causing the formation to hydrate, resulting in a swelling wellbore, which can result in a stuck pipe incident. The reverse situation, a low salinity formation and a high salinity drilling fluid, resulting in osmotic water flow from the formation into the drilling fluid, can produce a brittle, unstable wellbore that could potentially collapse, which can also result a stuck pipe incident. Accordingly, it is advantageous that the baseline drilling fluid water and salinity measurements be calibrated against wellbore flow conditions to assure that there is an osmotic balance between the fluid entering the well in relation to the fluid exiting the well. In one aspect of the invention, continuously provided water cut and chlorides concentration data can be utilized to assist in formulating an appropriate mud for a particular formation salinity. In one embodiment, if the continuously obtained water cut and chlorides concentration data is indicative of both migration of water into the active mud from the formation, and an increase in chlorides concentration in the active mud, this information can be communicated, either directly or indirectly, to the drill crew so that the salinity of the mud can be adjusted upward. In one embodiment, if the continuously obtained water cut and chlorides concentration measurement data is indicative of both a migration of water from the mud into the formation, and a decrease in chlorides concentration, this information can be communicated, either directly or indirectly, to the drill crew so that the salinity of the mud can be adjusted downward. In one embodiment, a computerized instrument, such as a programmable logic controller (PLC), can be utilized to automatically adjust the mud salinity as would be desired in either situation, based on the continuously obtained water cut and chlorides concentration data being communicated, either directly or indirectly, thereto.

In an additional aspect of the invention, the continuously obtained oil and water information, including oil/water ratio in the active mud, can be utilized to control drilling operations. It is known in the art that the oil/water ratio affects the “emulsion stability,” (also known as “electrical stability”), which is a measure of how well the water is being emulsified into the oil of the active mud. Deviations from an optimal oil/water ratio in the active mud can lead to an increase in water wet solids; that is, hydrated solids in the emulsion mud system adhering to each other and aggregating such that they tend to settle or sag, and adhere to metal surfaces. Such an increase in water wet solids is typically due to too low an oil/water ratio (i.e., too much water and/or too little oil) without adequate emulsifier and wetting agent, and tends to destabilize the emulsion. An influx of water can cause such an emulsion stability decrease, that can result in shaker screen blinding, and/or an increase in equivalent circulating density (ECD) that can result in sloughing (the partial or complete collapse of the wellbore resulting from incompetent, unconsolidated formations and wetting along the bedding planes). In one embodiment, if the continuously obtained oil and water information, and therefore the oil/water ratio data, is indicative of conditions giving rise to an emulsion instability, this information can be communicated, either directly or indirectly, to the drill crew so that the oil/water ratio in the active mud can be appropriately adjusted. In one embodiment, a computerized instrument, such as a programmable logic controller (PLC), can be utilized to automatically adjust the oil/water ratio as would be desired in an emulsion instability situation, based on the continuously obtained oil and water information, and therefore the oil/water ratio data, being communicated, either directly or indirectly, thereto.

One typical drilling operation occurrence is the loss of fluids, including loss of liquids (e.g., water) via evaporation. In a closed loop circulatory system, the material balance requires proper volume reconciliation to account for all volumes both lost and gained. Continuous volume measurement at both the suction line and flow line allows for near real-time computation of the flow rate differential (i.e., the volumetric flow rate entering into the well subtracted from the volumetric flow rate exiting the well). To maintain a stable drilling fluid, lost fluids must be replenished. Monitoring evaporation losses on a continuous basis contributes to accurate volume reconciliation. When it is determined that a volume of fluid has been lost, a “dilution volume” comprising replacement fluids (e.g., base oil) to compensate for volume losses due to, among other things, cuttings displacement, losses to the formation, losses due to waste volume generated, solids degradation, and evaporative losses, is added to the active mud. Obtaining a continuous mass balance (utilizing water cut, percentage oil, and chlorides concentration) of both the flow rate differential and any measured dilution volume being added allows for quantification of evaporation as it is occurring. More specifically, the percentage of oil and percentage of water lost to the formation can be calculated. The volume flow rate differential can be subtracted from the total fluid volume to provide an indication of the amount of oil and water in the system prior to adding a dilution volume. This will provide the correct material balance of water and oil in the circulatory system that indicates the volume of water that has been lost to evaporation. In addition, measuring flow rate of the diluents, (both base oil and water), continuously, enables measurement of an exact dilution rate, for example in one or more active mud tanks. In one embodiment, continuously obtained measurements, and therefore volume reconciliation data, can be communicated, either directly or indirectly, to the drill crew so that fluids content in the active mud can be appropriately adjusted. In one embodiment, a computerized instrument, such as a programmable logic controller (PLC), can be utilized to automatically adjust the fluids content in the active mud as would be desired based on the continuously obtained measurements, and therefore volume reconciliation data, being communicated, either directly or indirectly, thereto.

Another occurrence during drilling operations, known as “ballooning,” is the loss of drilling fluid into the formation during circulation, followed by migration of the lost fluid back into the wellbore when circulation has stopped. This typically involves downhole fluid pressure producing micro fractures in the formation, whereby mud can enter into the induced formation fractures. In a ballooning event, the returning lost fluid can contain various formation fluids which may include plain fresh water or water high in chlorides. In one aspect, an influx of water observed after circulation is re-commenced, absent an indication of abnormal pressures, can indicate that the event is a ballooning event as opposed to a well control incident. In one embodiment, continuously obtained water cut information can be communicated, either directly or indirectly, to the drill crew so that correlation thereof with wellbore pressure can be made to determine if a ballooning event has occurred. In one embodiment, a computerized instrument, such as a programmable logic controller (PLC), can be utilized to automatically adjust the drilling operations as would be desired for such a determined ballooning event, based on the continuously obtained water cut data being communicated, either directly or indirectly, thereto.

While the present invention has been disclosed and discussed in connection with the foregoing embodiments, it will be understood that the invention is not limited to the embodiments disclosed, but is capable of numerous rearrangements, modifications, and substitutions of steps and elements without departing from the spirit and scope of the invention.

We claim:

1. A method for monitoring a drilling operation in a wellbore, comprising at least one step selected from the group consisting of:
continuously measuring the water content of an active drilling fluid;
continuously measuring the oil content of an active drilling fluid; and
continuously measuring the salt anion content of an active drilling fluid.

2. The method of claim 1, comprising the steps of:
continuously measuring the water content of an active drilling fluid;
continuously measuring the oil content of said drilling fluid;
continuously measuring the salt anion content of said drilling fluid;
calculating a concentration of low gravity solids in said drilling fluid, using said continuously measured water content, said continuously measured oil content, and said continuously measured salt anion content; and
estimating a wellbore cleaning efficiency of said drilling operation, using said calculated concentration of low gravity solids.

3. The method of claim 1, comprising the steps of:
continuously measuring the water content of an active drilling fluid;
continuously measuring the oil content of said drilling fluid;
continuously measuring the salt anion content of said drilling fluid;
calculating a concentration of high gravity solids and a concentration of low gravity solids being removed from said drilling fluid, using said continuously measured water content, said continuously measured oil content, and said continuously measured salt anion content; and
estimating an efficiency of at least one solids control device using said calculated concentration of said high gravity solids and said calculated concentration of said low gravity solids.

4. The method of claim 1, comprising the steps of:
continuously measuring the water content of an active drilling fluid;
continuously measuring the oil content of said drilling fluid;
continuously measuring the salt anion content of said drilling fluid;
identifying an increase in circulating volume in said wellbore consistent with a wellbore influx; and
estimating, using said continuously measured water content, said continuously measured oil content, and said continuously measured salt anion content, if said influx comprises one or more components selected from the group consisting of:
water;
a salt;
a non-aqueous liquid; and
a gas.

5. The method of claim 1, comprising the steps of:
continuously measuring the water content of an active drilling fluid; and
estimating if a water loss to the formation has occurred, using said continuously measured water content.

6. The method of claim 1, comprising the steps of:
continuously measuring the water content of an active drilling fluid;
continuously measuring the salt anion content of said drilling fluid; and
estimating if an osmotic imbalance between said drilling fluid and a formation comprising said wellbore exists, using said continuously measured water content and said continuously measured salt anion content.

7. The method of claim 1, comprising the steps of:
continuously measuring the water content of an active drilling fluid;
continuously measuring the oil content of said drilling fluid;
calculating an oil/water ratio in said drilling fluid, using said continuously measured water content and said continuously measured oil content; and
estimating if said calculated oil/water ratio is consistent with emulsion instability of said drilling fluid.

8. The method of claim 1, comprising the steps of:
continuously measuring the water content of an active drilling fluid;
continuously measuring the oil content of said drilling fluid
continuously measuring the salt anion content of said drilling fluid; and
estimating if any water loss from said drilling fluid is attributable to evaporation, using said continuously measured water content, said continuously measured oil content, and said continuously measured salt anion content.

9. The method of claim 1, comprising the steps of:
continuously measuring the water content of an active drilling fluid; and
estimating if a ballooning event has occurred, using said continuously measured water content.

10. A method for controlling a downhole drilling operation, comprising:
at least one step selected from the group consisting of:
continuously measuring the water content of an active drilling fluid;
continuously measuring the oil content of an active drilling fluid; and
continuously measuring the salt anion content of an active drilling fluid; and
a step of controlling a drilling operation based at least in part on one or more estimations made using at least one measurement selected from the group consisting of:
said continuously measured water content;
said continuously measured oil content; and
said continuously measured salt anion content.

11. The method of claim 10, wherein said step of controlling a drilling operation comprises use of a data processing device.

12. The method of claim 10, comprising the steps of:
continuously measuring the water content of an active drilling fluid;
continuously measuring the oil content of said drilling fluid;
continuously measuring the salt anion content of said drilling fluid;
calculating a concentration of low gravity solids in said drilling fluid, using said continuously measured water content, said continuously measured oil content, and said continuously measured salt anion content;
estimating a cleaning efficiency of said drilling operation, using said calculated concentration of low gravity solids; and
controlling said drilling operation based at least in part on said estimated wellbore cleaning efficiency.

13. The method of claim 10, comprising the steps of:
continuously measuring the water content of an active drilling fluid;
continuously measuring the oil content of said drilling fluid;
continuously measuring the salt anion content of said drilling fluid;
calculating a concentration of high gravity solids and a concentration of low gravity solids being removed from said drilling fluid, using said continuously measured water content, said continuously measured oil content, and said continuously measured salt anion content;
estimating an efficiency of at least one solids control device using said calculated concentration of said high gravity solids and said calculated concentration of said low gravity solids; and
controlling said drilling operation based at least in part on said estimated efficiency of at least one said solids control device.

14. The method of claim 10, comprising the steps of:
continuously measuring the water content of an active drilling fluid;
continuously measuring the oil content of said drilling fluid;
continuously measuring the salt anion content of said drilling fluid;
identifying an increase in circulating volume in said wellbore consistent with a wellbore influx;
estimating, using said continuously measured water content, said continuously measured oil content, and said continuously measured salt anion content, if said influx comprises one or more components selected from the group consisting of:
water;
a salt;
a non-aqueous liquid; and
a gas; and
controlling said drilling operation based at least in part on said estimated influx.

15. The method of claim 10, comprising the steps of:
continuously measuring the water content of an active drilling fluid;
estimating if a water loss to the formation has occurred, using said continuously measured water content; and
controlling said drilling operation based at least in part on said estimated water loss.

16. The method of claim 10, comprising the steps of:
continuously measuring the water content of an active drilling fluid;
continuously measuring the salt anion content of said drilling fluid;
estimating if an osmotic imbalance between said drilling fluid and a formation comprising said wellbore exists, using said continuously measured water content and said continuously measured salt anion content; and
controlling said drilling operation based at least in part on said estimated osmotic imbalance.

17. The method of claim 10, comprising the steps of:
continuously measuring the water content of an active drilling fluid;
continuously measuring the oil content of said drilling fluid;
calculating an oil/water ratio in said drilling fluid, using said continuously measured water content and said continuously measured oil content;
estimating if said calculated oil/water ratio is consistent with emulsion instability of said drilling fluid; and
controlling said drilling operation based at least in part on said estimated emulsion instability.

18. The method of claim 10, comprising the steps of:
continuously measuring the water content of an active drilling fluid;
continuously measuring the oil content of said drilling fluid continuously measuring the salt anion content of said drilling fluid;
estimating if any loss of water from said drilling fluid is attributable to evaporation, using said continuously measured water content, said continuously measured oil content, and said continuously measured salt anion content; and
controlling said drilling operation based at least in part on said estimated evaporative water loss.

19. The method of claim 10, comprising the steps of:
continuously measuring the water content of an active drilling fluid;
estimating if a ballooning event has occurred, using said continuously measured water content; and
controlling said drilling operation based at least in part on said estimated ballooning event.

20. A method for estimating a material balance of an active drilling fluid comprising:
estimating the density of high gravity solids in said drilling fluid;
estimating the density of low gravity solids in said drilling fluid;
continuously measuring the water content of an active drilling fluid;
continuously measuring the oil content of said drilling fluid;
continuously measuring the salt anion content of said drilling fluid;
continuously measuring the density of said drilling fluid;
calculating a salinity of a water phase of said drilling fluid, using said continuously measured water content and said continuously measured salt anion content;
calculating a weight per unit volume salt anion concentration of a water phase of said drilling fluid, using said continuously measured water content and said continuously measured salt anion content;
calculating a brine volume factor of said drilling fluid, using said salt anion concentration of said water phase;
calculating a density of said water phase, using said salt anion concentration of said water phase;
calculating a relative amount of solids in said drilling fluid, using said continuously measured water content, and said continuously measured oil content;
calculating a relative concentration of said salt in said drilling fluid, using said continuously measured water content, said density of said water phase, and salinity of said water phase;
calculating a weight per unit volume concentration of said salt in said drilling fluid, using said salt anion content of said drilling fluid;
calculating a relative amount of said high gravity solids in said drilling fluid, using said continuously measured oil content, said continuously measured water content, said brine volume factor, and said density of said drilling fluid;
calculating a weight per unit volume concentration of said high gravity solids in said drilling fluid, using said relative amount of said high gravity solids in said drilling fluid and said density of said high gravity solids;
calculating a relative amount of said low gravity solids in said drilling fluid, using said continuously measured oil content, said continuously measured water content, said brine volume factor, and said relative amount of said high gravity solids in said drilling fluid;
calculating a weight per unit volume concentration of said low gravity solids in said drilling fluid, using said relative amount of said low gravity solids in said drilling fluid and said density of said low gravity solids; and
calculating an oil to water ratio in said drilling fluid, using said using said continuously measured oil content, said continuously measured water content, and said brine volume factor.
